(19) United States
(12) Patent Application Publication
(10) Pub. No.: US 2014/0188303 A1
(43) Pub. Date: Jul. 3, 2014

(54) ELECTRONIC APPARATUS, CONTROL METHOD AND STORAGE MEDIUM

(71) Applicant: Kabushiki Kaisha Toshiba, Tokyo (JP)

(72) Inventor: Nobuto Fujiwara, Hamura-shi (JP)

(73) Assignee: Kabushiki Kaisha Toshiba, Tokyo (JP)

(21) Appl. No.: 14/012,669

(22) Filed: Aug. 28, 2013

Related U.S. Application Data
(63) Continuation of application No. PCT/JP2013/058379, filed on Mar. 22, 2013.

(30) Foreign Application Priority Data
Dec. 27, 2012 (JP) 2012-285458

(51) Int. Cl. G05D 23/19

(52) U.S. Cl. CPC G05D 23/19
USPC 700/300; 700/299

(57) ABSTRACT

According to one embodiment, an electronic apparatus includes a main body, a temperature sensor, a circuit board and a temperature controller. The temperature sensor is provided inside of the main body and is configured to detect a temperature of the inside of the main body. The circuit board is provided in the main body and on which electronic parts are mounted. The temperature controller is mounted on the circuit board and is configured to control the temperature of the inside of the main body. The temperature controller is configured to perform operation control based on a predetermined time in accordance with the temperature detected by the temperature sensor.

### CROSS REFERENCE TO RELATED APPLICATIONS

This application is a Continuation Application of PCT Application No. PCT/JP2013/058379, filed Mar. 22, 2013 and based upon and claiming the benefit of priority from Japanese Patent Application No. 2012-285458, filed Dec. 27, 2012, the entire contents of all of which are incorporated herein by reference.

### FIELD

Embodiments described herein relate generally to an electronic apparatus, a control method and a storage medium, and, in particular, to a technique of controlling heat generation or heat radiation caused by an operation of the apparatus.

### BACKGROUND

An electronic apparatus such as a portable computer is downsized and thinned, and it is common to carry and use it. In recent years, an operation clock frequency of a CPU mounted in the electronic apparatus is improved, and speed and performance of the CPU are enhanced. As the speed and performance of the CPU are enhanced, power consumption increases and accordingly a heat value from the CPU also increases. If a housing is formed of material having good heat conductivity such as magnesium, heat generated from the CPU during use is conducted to the housing. If a user puts a portable computer on his or her lap to use it, the heat generated from the CPU is conducted to the lap through the housing and there is a risk of causing low temperature burn.

Jpn. Pat. Appln. KOKAI Publication No. 2006-293814 (Patent document 1) is cited as an example of solving this problem. The patent document 1 discloses a temperature control unit which changes a heat source load embedded in an electronic apparatus to control a surface temperature of the housing of the electronic apparatus. In the temperature control unit, a human body contact detection unit detects a human body being in contact with the housing, a temperature sensor measures a surface temperature of the housing, the temperature sensor also detects a heating temperature of the heat source, and when the surface temperature is higher than a first predetermined surface temperature while the human body being in contact is detected, a heat source controller decreases the load of the heat source by a first predetermined load.

According to the temperature control method of the patent document 1, if the human body comes in contact with the housing when a housing surface temperature is high, the heat source load is decreased. However, it may be touched at a temperature causing the low temperature burn until the temperature of the housing is lowered.

Also, according to the temperature control method of the patent document 1, the temperature is sensed by the temperature sensor in order not to exceed a given standard temperature, and the number of FAN rotations and power consumption are controlled in a control IC. Thus, to prevent a user from causing the low temperature burn, the housing surface temperature had to be kept at a temperature equal to or lower than the temperature which is absolutely unable to cause the low temperature burn (e.g., a surface had to be always equal to or lower than 44° C.)

On the other hand, since software comprising large load change is executed, the rotation speed of the CPU should be sometimes increased even though the surface temperature is raised to some extent. Accordingly, controlling the power consumption uniformly was not optimal operation control.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary external perspective view of an electronic apparatus according to an embodiment.

FIG. 2 is an exemplary sectional view illustrating an internal structure of the electronic apparatus according to the embodiment.

FIG. 3 is an exemplary block diagram illustrating a structure of the electronic apparatus according to the embodiment.

FIG. 4 is an exemplary flowchart illustrating an operation of the electronic apparatus according to the embodiment.

FIG. 5 is an exemplary drawing illustrating a relationship between a temperature and a time stored in the electronic apparatus according to the embodiment.

### DETAILED DESCRIPTION

Various embodiments will be described hereinafter with reference to the accompanying drawings.

In general, according to one embodiment, an electronic apparatus includes a main body, a temperature sensor, a circuit board and a temperature controller. The temperature sensor is provided inside of the main body and is configured to detect a temperature of the inside of the main body. The circuit board is provided in the main body and on which electronic parts are mounted. The temperature controller is mounted on the circuit board and is configured to control the temperature of the inside of the main body. The temperature controller is configured to perform operation control based on a predetermined time in accordance with the temperature detected by the temperature sensor.

FIG. 1 is an exemplary external perspective view of an electronic apparatus according to an embodiment. In this embodiment, a notebook computer is used as an example to explain the electronic apparatus. A notebook computer 1 includes a main body 2, and a display unit 3 is rotatably attached to the main body 2 via a hinge 4. A touch pad 5 and a palm rest 6 are attached to a front top surface 2a of the main body 2. A keyboard 7 is attached to a rear top surface 2b of the main body 2. The main body 2 includes an upper case 8 and a lower case 9 made of resin or metal such as magnesium alloy, and the circuit board with a plurality of electronic parts which is to be described is contained in the main body 2.

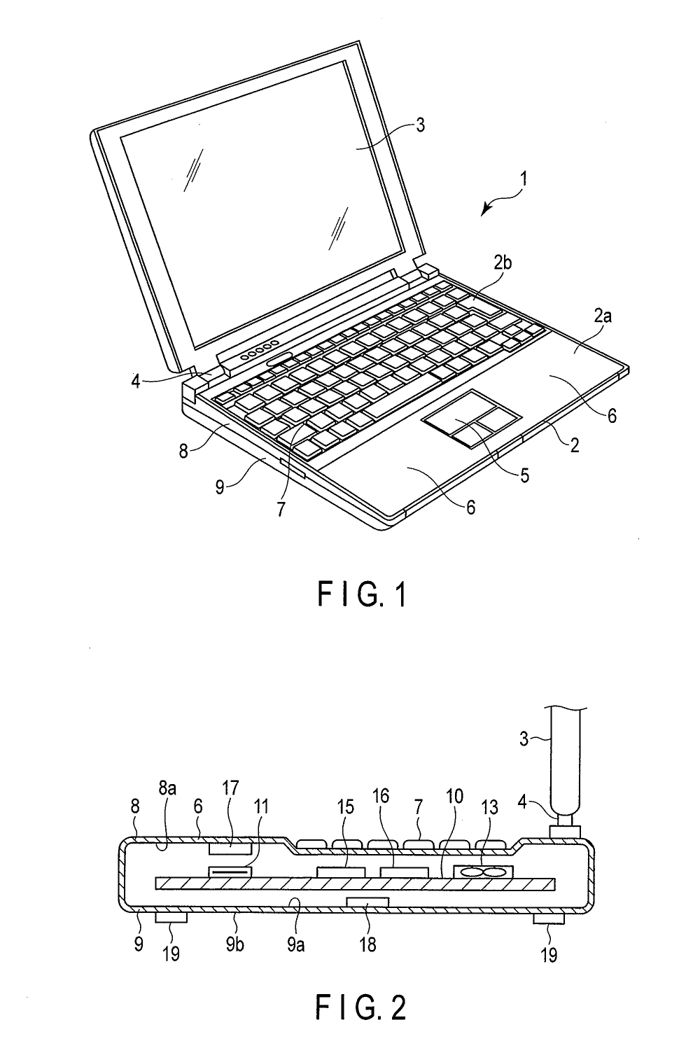

FIG. 2 is an exemplary sectional view illustrating an internal structure of the electronic apparatus according to the embodiment. A circuit board 10 with the plurality of electronic parts is contained in the main body 2. Parts of a CPU 11 etc. generating heat during operation are mounted on the circuit board 10. To diffuse the heat from the CPU 11 generated during operation, a heat sink not shown is provided inside the main body 2, the heat sink being made of metal. A fin for increasing an area being in contact with air is integrally formed in the heat sink. A fan 13 for cooling the inside of the main body 2 is provided in the main body 2. The fan 13 is mounted on the circuit board 10 in the main body 2. The fan 13 and the heat sink may be integrally formed and mounted on the circuit board 10.

The temperature sensor 15 detects the temperature of the circuit board 10. The temperature controller 16 consists of, e.g., an IC for temperature control, and controls the temperature of the circuit board 10. The relationship between the temperature of the circuit board 10 and that of the main body 2 may be checked in advance to control the temperature of the main body 2. Also, the temperature sensor 15 may be placed directly on the main body 2 to control the temperature based on the measured temperature.

A pressure sensor 17 is provided at an inner surface 8a of the upper case 8 corresponding to the palm rest 6. A pressure sensor 18 for detecting pressure applied on the lower case 9 is provided at an inner surface 9a of the lower case 9. A leg 19 supporting the main body 2 is provided at a bottom surface 9b of the lower case 9.

When the main body 2 is put on a flat table etc., it is desirable that the main body 2 be supported by the leg 19 and not be in contact with the pressure sensor 18. The pressure sensors 17 and 18 may be provided to be exposed to the palm rest 6 of the upper case 8 or the bottom surface 9b of the lower case. Instead of the pressure sensor 17, a light sensor may be provided in the palm rest 6 of the main body front top surface 2a. For example, a light sensitive element is used for the light sensor. When a hand is put on the palm rest 6 during use, the amount of light detected by the light sensor changes. Whether the hand of a user is put on the palm rest 6 or not may be detected using a set of a light receiving element and a light emitting element. When it is determined that the user's hand is put on the palm rest 6 based on the detected amount of light, the electronic apparatus instructs the temperature controller 16 to control the peripheral temperature of the palm rest 6. The processing of controlling the temperature of the main body 2 prevents the user from causing low temperature burn when the user's hand is put on the palm rest 6.

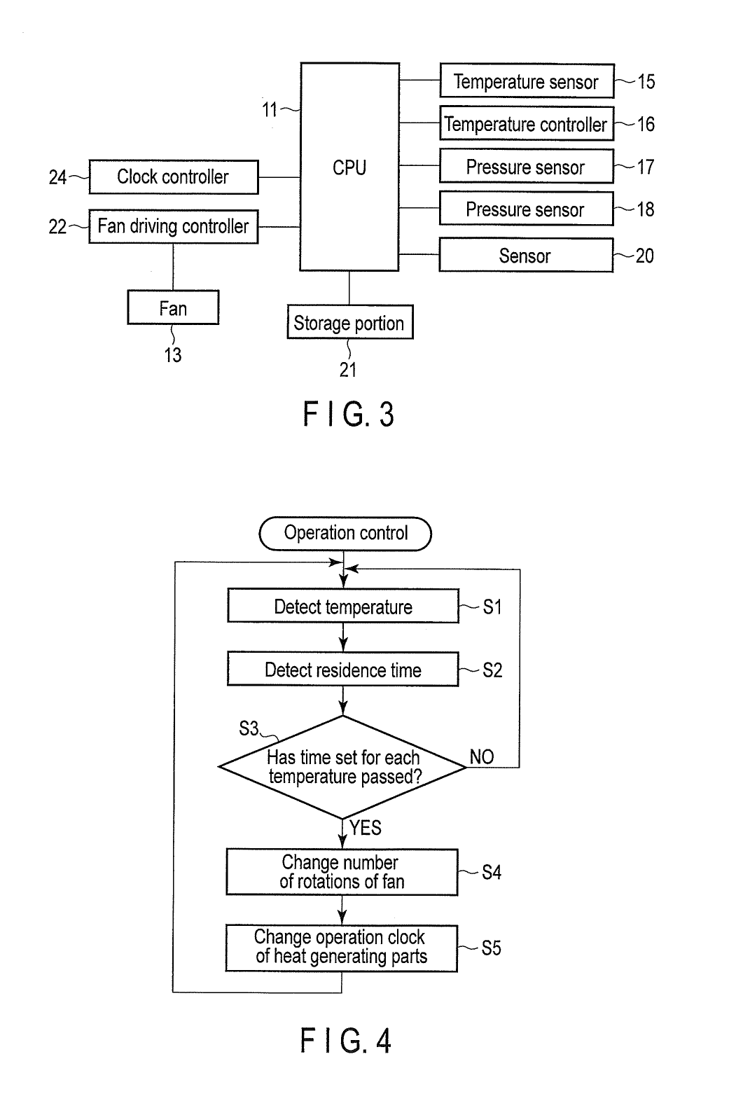

FIG. 3 is an exemplary block diagram illustrating a structure of the electronic apparatus according to the embodiment. A system of the electronic apparatus according to the embodiment mainly includes the CPU 11, the fan 13, the temperature sensor 15, the temperature controller 16, the pressure sensor 17, the pressure sensor 18, a timer 20, a storage portion 21, a fan driving controller 22, a clock controller 24, etc. Each of the structural elements is connected to the CPU 11 and controlled.

For example, a thermistor, a temperature sensor IC, etc. are used for the temperature sensor 15. The temperature controller 16 consists of the IC for temperature control etc., and controls the temperature of the circuit board 10 by controlling the fan driving controller 22 and the clock controller 24. The temperature controller 16 may control the temperature of the whole of the circuit board 10. Alternatively, a plurality of temperature controllers 16 corresponding to parts having a large heat value such as the CPU 11, a video graphic array (VGA) and a memory may be provided. For example, the temperature of the CPU 11 itself may be read by the CPU 11, and that of the CPU 11 may be controlled by a basic input output system (BIOS) and an embedded controller (EC). It should be noted that the temperature controller 16 may be incorporated into the CPU 11 and can be operated either by software or by hardware.

For example, a semiconductor strain gage is used for the pressure sensors 17 and 18. The semiconductor strain gage detects transformation by external pressure as change of electric resistance, and senses the pressure.

The timer 20 starts time counting when the temperature detected by the temperature sensor 15 changes.

The storage portion 21 consists of a hard disc drive, a flash memory, etc. Not only various programs and data but the relationship between the temperature of the circuit board 10 and that of the housing checked in advance are stored in the storage portion 21.

The fan driving controller 22 drives and controls the fan 13 based on instructions of the temperature controller 16. The number of rotations of the fan 13 can be controlled.

The clock controller 24 controls a clock frequency of IC parts which are heat generating parts of the CPU 11 etc. based on the instructions of the temperature controller 16. The processing speed of the CPU 11 is reduced as the clock frequency is lowered. The heat value is reduced in accordance with the reduction of the processing speed of the CPU 11, and an amount of heat transfer to the upper case 8 and the lower case 9 is also reduced. Thus, the temperature of the main body 2 can be reduced.

FIG. 4 is an exemplary flowchart illustrating an operation of the electronic apparatus according to the embodiment. The temperature detected from the temperature sensor 15 is confirmed when the notebook computer 1 is used (step 1). A residence time corresponding to the detected temperature is read out from the storage portion 21 (step 2).

The temperature controller 16 compares a result of the counting of the timer 20 and the read-out residence time, and determines whether the residence time has passed or not (step 3). If the residence time has passed (Yes of step 3), the fan driving controller 22 increases the number of rotations of the fan 13 (step 4), the clock controller 24 reduces an operation clock of the heat generating parts (step 5), improves cooling efficiency and lowers the temperature.

It should be noted that although the temperature controller 16 controls the fan driving controller 22 and the clock controller 24 and controls the operation to lower the temperature after the residence time has passed in this embodiment, the operation may be controlled to lower the temperature before the residence time has passed. In this case, the preset residence time can be set to be slightly longer.

Also, both of increasing the number of rotations of the fan 13 and reducing the operation clock of the CPU 11 etc. are performed in this embodiment. Both of the operations are, however, not necessarily controlled. If it is sufficient to operate either of them to lower the temperature, either operation can be controlled. For example, in order to lower the temperature, only the number of rotations of the fan 13 can be increased without performing the processing of reducing the clock frequency of the CPU 11. This is effective if the temperature should be lowered without decreasing processing capacity of the CPU 11.

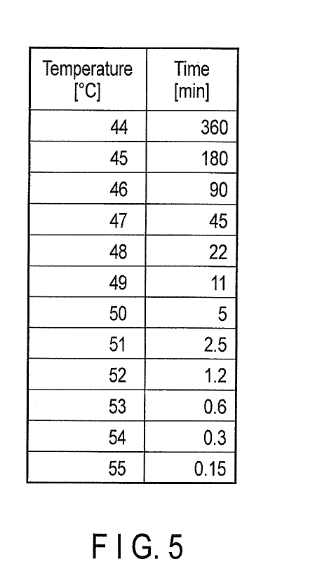

FIG. 5 is an exemplary drawing illustrating a relationship between a temperature and a time stored in the electronic apparatus according to the embodiment.

The residence time in the temperature preset for each temperature is stored in the storage portion 21. If temperature is 49° C., 11 minutes is stored. The temperature controller 16 controls the fan driving controller 22 and the clock controller 24 such that the temperature can be turned to be 48° C. before 11 minutes pass, e.g., if the temperature is 49° C. It should be noted that this residence time is a guide. When it is actually applied to a product, an appropriate time should be set in accordance with the size etc. of the housing.

In the above-described embodiment, operation control is performed by detecting the temperature of the electronic apparatus. The operation control may be performed only when a human body being in contact with the main body 2 is sensed by the pressure sensors 17 and 18 or the light sensor provided in the palm rest and the bottom surface of the housing. Then, a risk of the low temperature burn etc. caused by the human contact can be reduced.

The example in which the electronic apparatus is realized as a notebook personal computer is explained in the above-described embodiment. The electronic apparatus may be realized as a tablet personal computer, a portable TV and a portable DVD player.

The method described in the above-described embodiment can be stored in a storage medium such as a magnetic disc (a flexible disc, a hard disc, etc.), an optical disc (a CD-ROM, a DVD, etc.), a magnetic optical disc (an MO) and a semiconductor memory and distributed as a program which can be executed by a computer.

Also, the memory format of this storage medium can be any form if the storage medium can store a program and a computer is readable storage medium.

Also, an operating system (OS), middleware (MW) such as database-management software and network software, etc. operating in the computer based on the instructions of the program installed in the computer from the storage medium may execute part of each of processes for realizing this embodiment.

Furthermore, the storage medium of this embodiment may consist of not only a medium independent from the computer but a storage medium stored or temporarily stored by downloading a program transmitted by a LAN, the Internet, etc.

Also, the number of storage media is not limited to one. The storage medium of this embodiment includes the case where the processing of this embodiment is executed by a plurality of media, and the structure of the medium can be any structure.

The function of each module explained in the above embodiment may be realized by a software application executed by a processor, by a processing circuit of hardware, by the hardware, or by a combination of the software application, the hardware and a software module.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a main body;
a temperature sensor provided inside of the main body and configured to detect a temperature of the inside of the main body;
a circuit board provided in the main body and on which electronic parts are mounted; and
a temperature controller mounted on the circuit board and configured to control the temperature of the inside of the main body,
wherein the temperature controller is configured to perform operation control based on a predetermined time in accordance with the temperature detected by the temperature sensor.

2. The apparatus of claim 1, wherein the predetermined time in accordance with the temperature detected by the temperature sensor comprises a residence time in the temperature preset for each temperature.

3. The apparatus of claim 2, wherein the operation control comprises to increase a number of rotations of a fan for cooling the electronic parts.

4. The apparatus of claim 3, wherein the operation control comprises to lower an operation clock of the electronic parts.

5. The apparatus of claim 4, further comprising a pressure sensor provided in the main body,
wherein the temperature controller is configured to perform the operation control when the pressure sensor detects a predetermined pressure.

6. The apparatus of claim 3, further comprising a pressure sensor provided in the main body,
wherein the temperature controller is configured to perform the operation control when the pressure sensor detects a predetermined pressure.

7. The apparatus of claim 2, wherein the operation control comprises to lower an operation clock of the electronic parts.

8. The apparatus of claim 7, further comprising a pressure sensor provided in the main body,
wherein the temperature controller is configured to perform the operation control when the pressure sensor detects a predetermined pressure.

9. The apparatus of claim 2, further comprising a pressure sensor provided in the main body,
wherein the temperature controller is configured to perform the operation control when the pressure sensor detects a predetermined pressure.

10. The apparatus of claim 1, wherein the operation control comprises to increase a number of rotations of a fan for cooling the electronic parts.

11. The apparatus of claim 10, wherein the operation control comprises to lower an operation clock of the electronic parts.

12. The apparatus of claim 11, further comprising a pressure sensor provided in the main body,
wherein the temperature controller is configured to perform the operation control when the pressure sensor detects a predetermined pressure.

13. The apparatus of claim 10, further comprising a pressure sensor provided in the main body,
wherein the temperature controller is configured to perform the operation control when the pressure sensor detects a predetermined pressure.

14. The apparatus of claim 1, wherein the operation control comprises to lower an operation clock of the electronic parts.

15. The apparatus of claim 14, further comprising a pressure sensor provided in the main body,
wherein the temperature controller is configured to perform the operation control when the pressure sensor detects a predetermined pressure.

16. The apparatus of claim 1, further comprising a pressure sensor provided in the main body,
wherein the temperature controller is configured to perform the operation control when the pressure sensor detects a predetermined pressure.

17. A control method for controlling a temperature of an inside of a main body of an electronic apparatus comprising the main body, a temperature sensor provided inside the main body and configured to detect the temperature of the inside of the main body, and a circuit board provided in the main body and on which electronic parts are mounted, the method comprising:
performing operation control based on a predetermined time in accordance with the temperature detected by the temperature sensor.

18. A computer-readable, non-transitory storage medium having stored thereon a computer program which is executable by a computer comprising the main body, a temperature sensor provided inside the main body and configured to detect a temperature of an inside of the main body, and a circuit board provided in the main body and on which electronic parts are mounted, the computer program controlling the computer to execute function of:
controlling the temperature of the inside of the main body,
wherein the controlling comprises performing operation control based on a predetermined time in accordance with the temperature detected by the temperature sensor.
